(19) United States
(12) Patent Application Publication
(10) Pub. No.: US 2008/0077420 A1
(43) Pub. Date: Mar. 27, 2008

(54) System and Method for Securely Updating Remaining Time or Subscription Data for a Rental Computer

(76) Inventors: Daryl Cromer, Cary, NC (US); Howard Jeffrey Locker, Cary, NC (US); Randall Scott Springfield, Chapel Hill, NC (US); Rod D. Waltermann, Rougemont, NC (US)

Correspondence Address: LENOVO - JVL;C/O VANLEEUWEN & VANLEEUWEN, P.O. BOX 90609, AUSTIN, TX, 78709-0609, US

(21) Appl. No.: 11/612,300

(22) Filed: Dec. 18, 2006

Related U.S. Application Data
(63) Continuation-in-part of application No. 11/535,538, filed on Sep. 27, 2006.

(51) Int. Cl. G06Q 10/00

(52) U.S. Cl. 705/1

(57) ABSTRACT

A system, method, and program product is provided that manages a rental computer system by verifying installation of a secure time-day module in a computer system. The computer system is rendered inoperable if the secure time-day module is not installed. A current time-day value is retrieved from the secure time-day module and an end time-day value is retrieved from a secure storage area. The current time-day value is compared to the end time-day value in order to determine whether a rental period has expired. If the rental period has expired, then the user is prevented from using the rental computer system.

### RELATED APPLICATION

This application is a continuation-in-part (CIP) to the following co-pending U.S. Patent Application with at least one common inventor and assigned to the same assignee: Ser. No. 11/535,538 filed on Sep. 27, 2006 and titled “METHOD AND APPARATUS FOR PREVENTING UNAUTHORIZED MODIFICATIONS TO RENTAL COMPUTER SYSTEMS.”

### BACKGROUND OF THE INVENTION

1. Technical Field

The present invention relates to a system and method that updates remaining time or subscription data for a rental computer. More particularly, the present invention relates to a system and method that updates remaining time or subscription data using a secure time-day card.

2. Description of the Related Art

When dealing with computers, some companies (or users) prefer leasing or renting over purchasing. The lease term of a computer lease typically lasts from two to four years. On the other hand, a company can rent a computer on a monthly basis or on a per usage basis. Thus, the decision of whether to lease or to rent computers tends to depend on the length of time a company plans to keep its lease/rental computers.

From a user standpoint, one challenge associated with computer leasing is to make sure all lease computers are returned at the end of a computer lease; otherwise, the user must continue to pay at the lease rate for any lease computers that have not been returned. From a rental company's standpoint, one challenge associated with computer rental is to prevent renters from performing unauthorized modifications to rental computers so that the renters can still use their rental computers while without paying the required rental fees.

The present disclosure provides a method and apparatus for preventing unauthorized modifications to rental computers such that it would not be practical and/or cost effective to modify rental computers simply to avoid paying the required rental fees.

### SUMMARY

It has been discovered that the aforementioned challenges are resolved using a system, method and computer program product that manages a rental computer system by verifying installation of a secure time-day module in a computer system. The computer system is rendered inoperable if the secure time-day module is not installed. A current time-day value is retrieved from the secure time-day module and an end time-day value is retrieved from a secure storage area. The current time-day value is compared to the end time-day value in order to determine whether a rental period has expired. If the rental period has expired, then the user is prevented from using the rental computer system.

In one embodiment, after determining that the rental period has expired, the rental computer system is rebooted and a secure operating system is loaded. The secure operating system limits execution of software programs to those that facilitate purchase of additional rental time. In a further embodiment to this alternative, a program is executed to purchase additional rental time by sending a request for the additional rental time to a server that is connected to the computer system via a computer network, with the request including payment information. The server returns a rental request response, and the end time-day value is updated and stored in the secure storage area based on the received rental request response. In a further alternative, if the additional rental time is requested using the non-secure operating system, then the rental request response received from the server is stored in a predetermined storage location and, when the rental period has expired, the received rental request response is retrieved from the predetermined storage location and used to update the end time-day value stored in the secure storage area.

In one embodiment, the determination as to whether the rental period has expired is repeatedly performed, including when the rental computer system is initially booted. In this embodiment, a predefined memory location is read when the rental period is expired in order to determine whether additional rental time has been purchased. When additional rental time has been purchased, the end time-day value is updated using data stored in the predefined memory location, and the user is allowed continued use of the rental computer system. However, if additional rental time has not been purchased, then a secure operating system flag is set and the rental computer system is rebooted. During the rebooting, a BIOS routine operates and loads a secure operating system based on the setting of the secure operating system flag. The secure operating system limits actions performed on the computer system to allowed actions with allowed actions including the purchase of additional rental time.

In another embodiment, when the rental computer system is booted, a secure boot routine execute that reads a secure operating system flag from a predefined memory location. The secure boot routine loads and executes a non-secure operating system in response to the secure operating system flag being cleared, and the secure boot routine loads and executes the secure operating system in response to the secure operating system flag being set. During execution of the secure operating system, the user sends a request for additional rental time to a server that is connected to the computer system via a computer network. The request includes payment information. The rental web server sends a response that is used to update the end time-day value stored in the secure storage area. Then the current time-day value is compared to the updated end time-day value and determination is made as to whether the rental period has expired. If the rental period is no longer expired, then the secure operating system flag is cleared and the rental computer system is rebooted. On the other hand, if the rental period is still expired, then the rental computer system is made inoperable (e.g., by loading the secure operating system rather than the user's normal operating system).

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a rental computer system in which a preferred embodiment of the present invention is incorporated;

FIG. 2 is a block diagram of an apparatus for preventing unauthorized modifications to rental computer systems, in accordance with a preferred embodiment of the present invention;

FIG. 3 is a high-level logic flow diagram of a method for setting secure time/day to prevent unauthorized modifications to rental computer systems, in accordance with a preferred embodiment of the present invention;

FIG. 4 is a high-level logic flow diagram of a method for preventing unauthorized modifications to rental computer systems, in accordance with a preferred embodiment of the present invention;

FIG. 5 is a flowchart showing the steps performed by the time-day card in updating rental subscription data;

FIG. 6 is a flowchart showing the steps taken by a secure BIOS routine to enforce subscription rules;

FIG. 7 is a flowchart showing the steps taken to purchase additional rental time;

FIG. 8 is a flowchart showing further steps taken during the purchase and update of the additional rental time;

FIG. 9 is a diagram showing components used in the rental computer system; and

FIG. 10 is a block diagram of a data processing system in which the methods described herein can be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

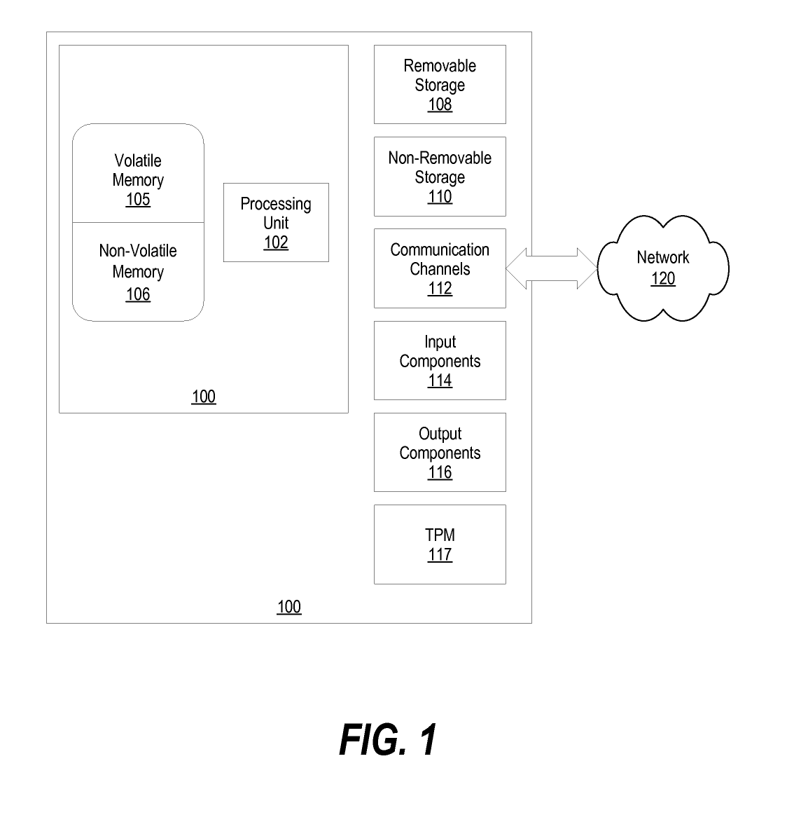

Referring now to the drawings and in particular to FIG. 1, there is depicted a block diagram of a rental computer system in which a preferred embodiment of the present invention is incorporated. As shown, a rental computer system 100 includes a processing unit 102 and a memory 104. Memory 104 includes a volatile memory 105 (such as a random access memory) and a non-volatile memory 106 (such as a read-only memory). Rental computer system 100 also contains removable storage media devices 108, such as compact discs, optical disks, magnetic tapes, etc., and non-removable storage devices 110, such as hard drives. In addition, rental computer system 100 may contain communication channels 112 for providing communications with other systems on a computer network 120. Rental computer system 100 may also have input components 114 such as a keyboard, mouse, etc., and output components 116 such as displays, speakers, printers, etc.

A Trusted Platform Module (PPM) 117 is included within rental computer system 100 to provide secure generations of cryptographic keys, and limits the use of those keys to signing/verification or encryption/decryption, as it is known to those skilled in the art. TPM 117 can be utilized to ensure that data being used to grant access to the operating system of rental computer system 100 is maintained securely.

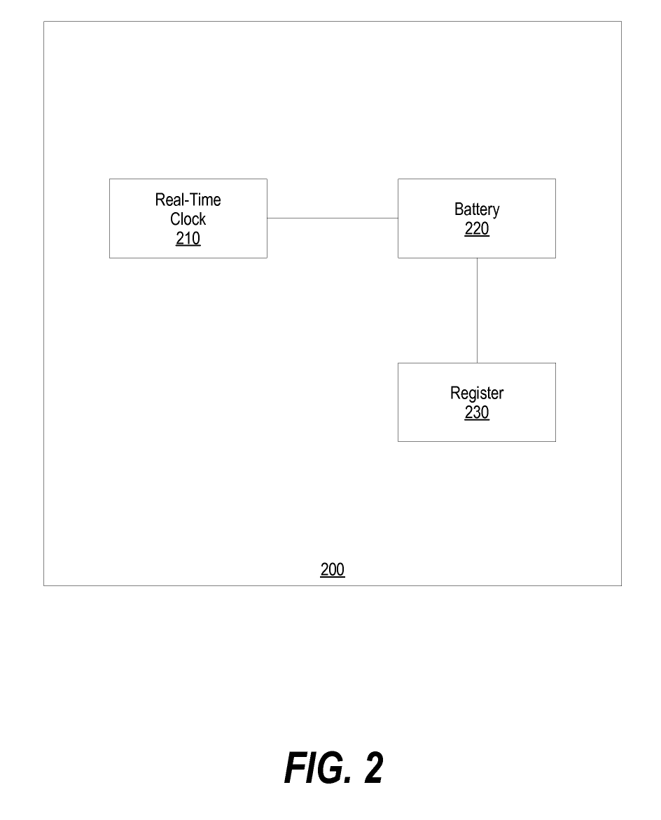

With reference now to FIG. 2, there is depicted a block diagram of an apparatus for preventing unauthorized modifications to rental computer systems, in accordance with a preferred embodiment of the present invention. As shown, a time-day card 200 includes a real-time clock 210 and a battery 220. Time-day card 210 also includes a register 230 and a counter 240. Register 230 is used to indicate whether or not battery 220 has been removed and/or drained of its power. For example, a bit within register 230 can be locked in response to battery 220 being removed or the power of battery 220 has all been drained. Preferably, time-day card 210 is to be inserted into one of the memory sockets, such as SIMM or DIMM memory sockets, on a motherboard of a rental computer system, such as rental computer system 100 from FIG. 1. Real time clock 210 can be then accessed via a bus connected to the rental computer system. The time and day of time-day card 210 are initially set during the manufacturing of the rental computer system.

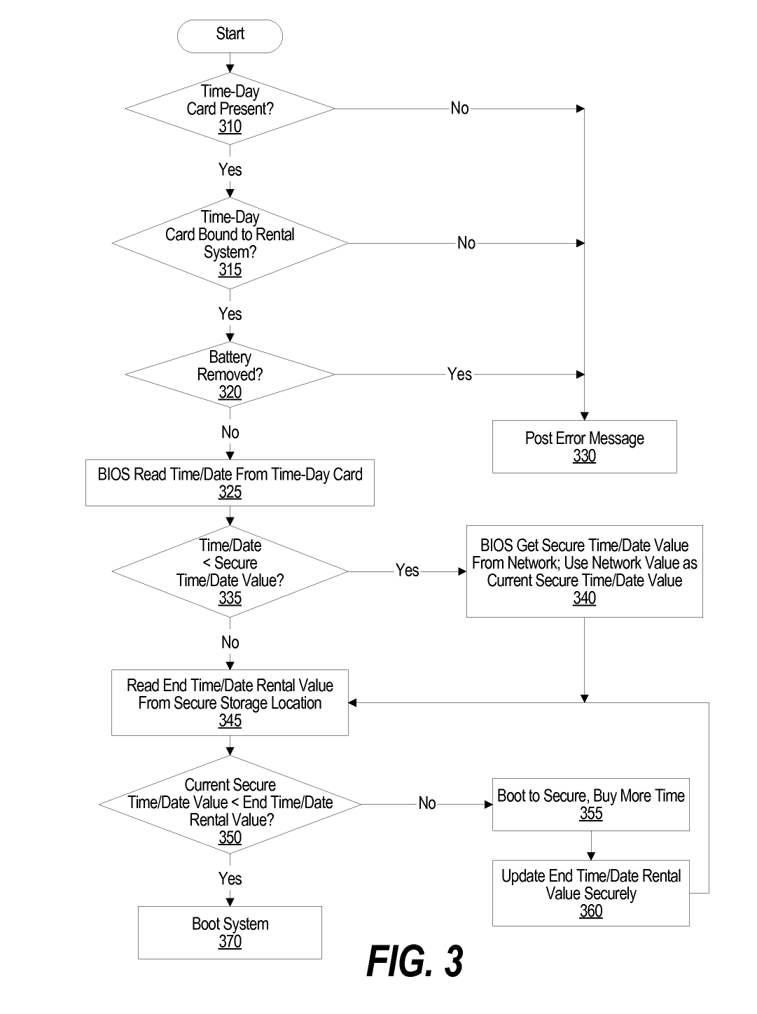

Referring now to FIG. 3, there is illustrated a high-level logic flow diagram of a method for setting secure time/day value to prevent unauthorized modifications to rental computer systems, in accordance with a preferred embodiment of the present invention. During power-on self test (POST), the basic input/output system (BIOS) determines whether or a time-day card, such as time-day card 210 from FIG. 2, is present in a rental computer system, as shown in block 310. This is accomplished by checking a counter chip that has registers for containing certain addresses with the correct information that is bound to the BIOS at time of manufacturing; thus, the time-day card is only valid in one rental computer system. In other words, the time-day card cannot be moved from one rental computer system to another.

If the time-day card is present, then another determination is made as to whether or not the time-day card is bound to the rental computer system, as depicted in block 315. The binding is a simple private/public key using a TPM. If the time-day card is removed from the rental computer system, the BIOS will not boot, thereby making the rental computer system inoperable. If the time-day card is bound to the rental computer system, another determination is made as to whether a battery on the time-day card has been removed, as shown in block 320. If the battery on the time-day card has not been removed, the BIOS reads the time/date information from the real-time clock of the time-day card, as depicted in block 325.

If the time-day card is not present, or if the time-day card is not bound to the rental computer system, or if the battery on the lime-day card has been removed or drained of its power, the POST stops to display an error message, and the rental computer system will not continue to boot, as shown in block 330.

The time/date information from the real-time clock of the time-day card are 5 compared to a current secure time/date value stored in a secure storage location during last power down (or manufacturing value if first power on). A determination is made as to whether or not the time/date information from the real-time clock is less than the current secure time/date value, as depicted in block 335. [f the time/day information is less than the current secure time/date value, then the BIOS obtains a new secure lime/date value from a network, and the new secure time/date value from the network becomes the current secure time/date value, as shown in block 340, and the process proceeds to block 345. If the lime/day information is not less than the current secure time/date value, then the end of time/date rental value is securely read from a secure storage location, as depicted in block 345.

Next, a determination is made as to whether or not the current secure time/date value is less than the end time/date rental value, as shown in block 350. If the current secure time/date value is not less than the end time/date rental value, the renter is prompted to buy more rental time on the rental computer (via a secure buy routine from BIOS), as depicted in block 355. After more rental time has been purchased by the renter, the end time/date rental value stored in the secure storage location is updated securely, as shown in block 360, and the process proceeds to block 345.

Otherwise, if the secure time/date value is less than the end time/date rental value, the rental computer system continues to boot, as shown in block 370.

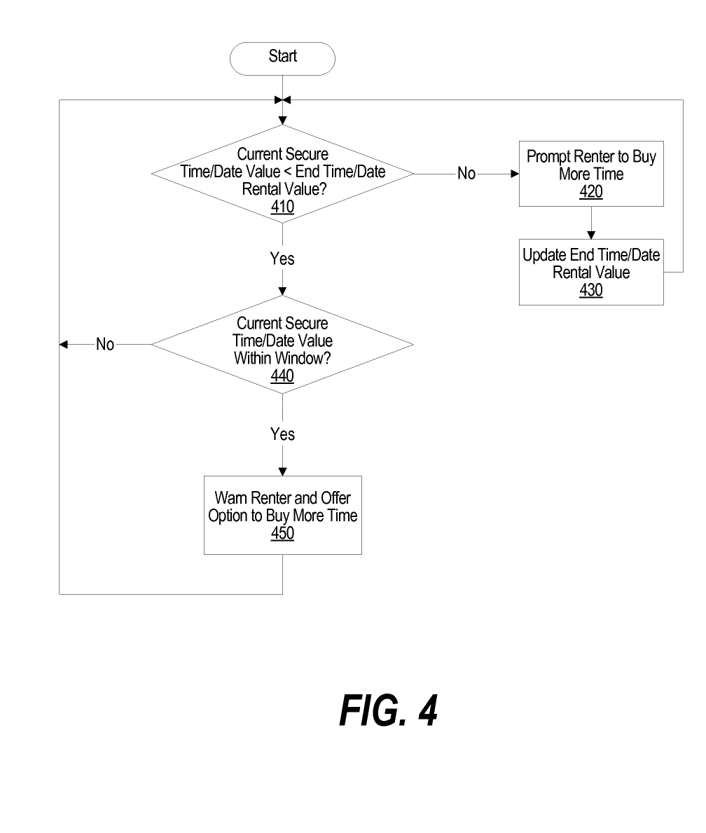

With reference now to FIG. 4, there is illustrated a high-level logic flow diagram of a method for preventing unauthorized modifications to rental computer systems, in accordance with a preferred embodiment of the present invention. Since SMI BIOS is always running every x units of time, the SMI BIOS can be utilized to determine if the current secure time/date value is less than the end time/date rental value on a regular basis, as shown in block 410. If the current secure time/date value is not less than the end time/date rental value, the renter is prompted to buy more rental time on the rental computer, as depicted in block 420. After more rental time has been purchased by the renter, the end time/date value is updated securely, as shown in block 430, and the process returns to block 410.

If the current secure time/date value is less than the end time/date rental 10 value, another determination is made as to whether or not the current secure time/date value falls within a window of the end time/date value, as shown in block 440. The size of the window is policy driven. For example, the window can be three days from the end time/date value. If the current secure time/date value falls within the window, the renter is warned more rental needs to be purchased soon and the renter is offered an option to purchase more rental time, as depicted in block 450. If the current secure time/date value does not fall within the window, the process returns to block 410.

As has been described, the present invention provides a method and apparatus for preventing unauthorized modifications to rental computer systems. The present invention uses a time-day card and a secure BIOS to prevent any unauthorized tampering to a rental computer system. With the time-day card, it is impossible for a renter to modify the date on a rental computer system. As such, a renter cannot fake the amount of usage time remaining on a rental computer system.

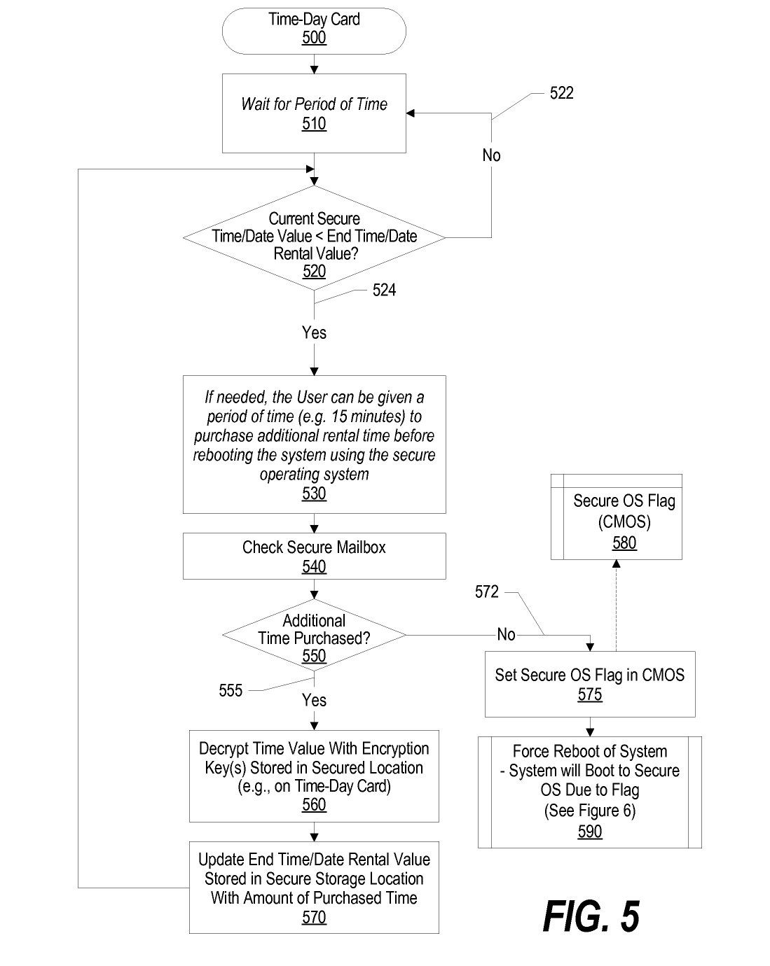

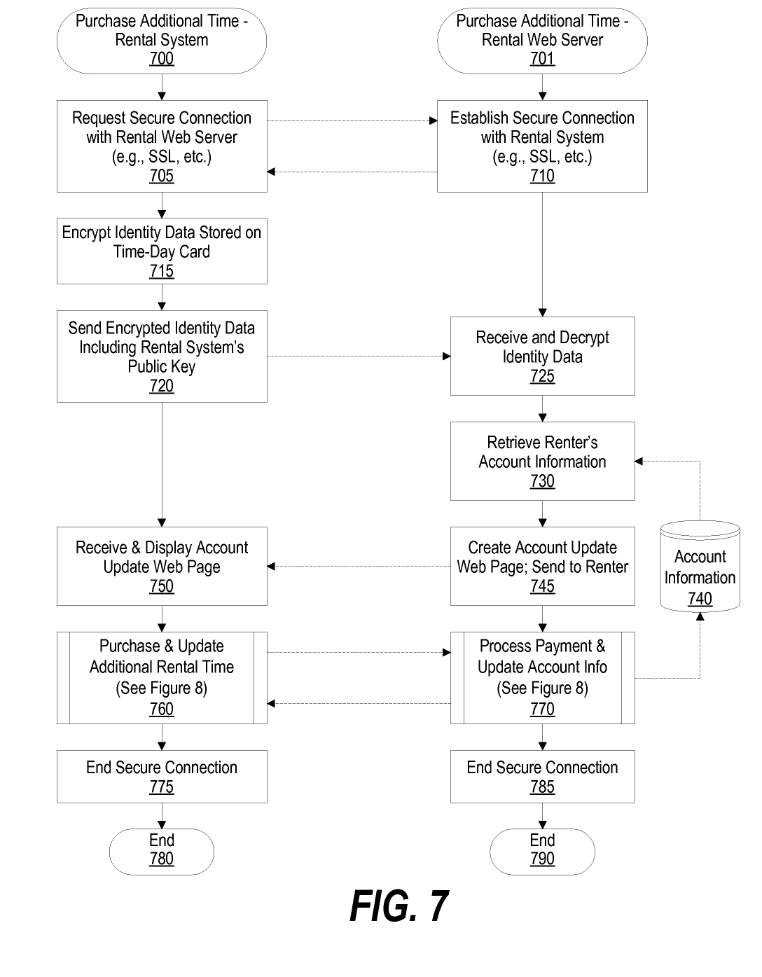

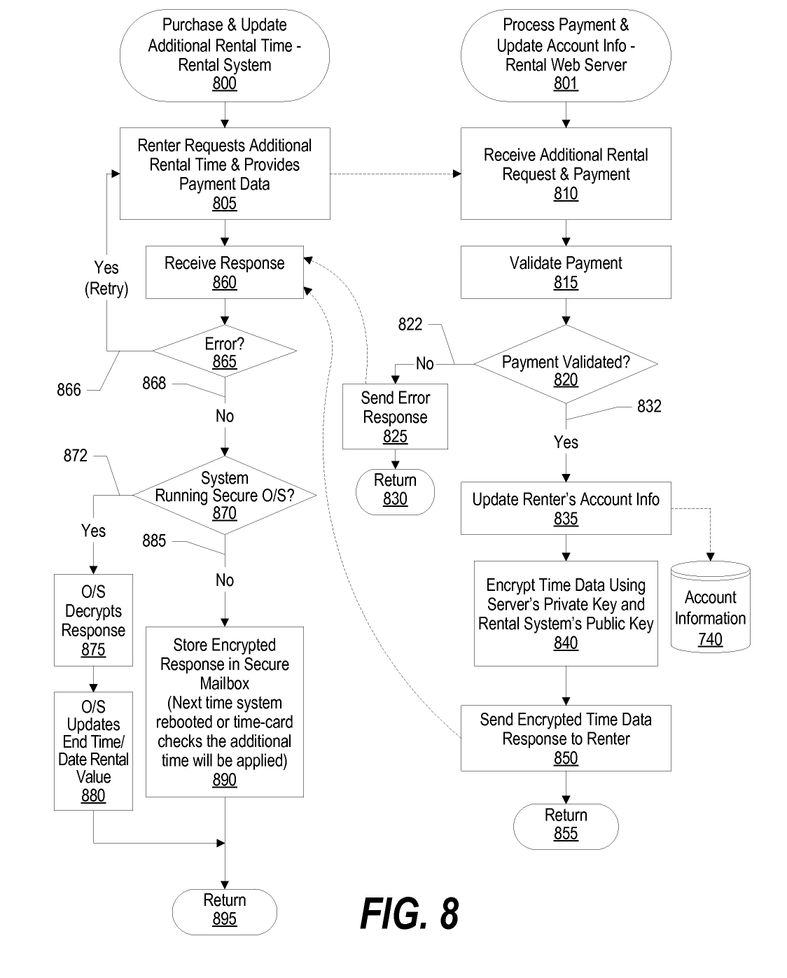

FIG. 5 is a flowchart showing the steps performed by the time-day card in updating rental subscription data. Processing commences at 500 whereupon, at step 510, processing waits for a period of time (e.g., one minute, etc.) before determining whether the rental time period has expired (decision 520) by comparing the current time-day value to the end time-day value purchased by the user. If the rental period has not expired, then decision 520 branches to “yes” branch 522 which loops back to step 510 and this looping continues until the amount of purchased rental time has expired. In one embodiment, using a separate routine shown in FIGS. 7 and 8, the user can periodically purchase additional rental time before the rental time expires.

If the comparison of the current time-day value to the end time-day value reveals that the purchased rental period has expired, then decision 520 branches to “yes” branch 524. At step 530, if needed, the user can be given a period of time, such as 15 minutes, to purchase additional rental time before rebooting the system using the secure operating system. In addition, a warning can be displayed to the user asking the user to purchase additional time or the computer system will reboot and load a secure operating system. At step 540, a predefined memory location, such as a secure mailbox, is checked for a response from a rental server. In one embodiment, the predefined memory location is used to store an encrypted rental response to prevent the user from hacking the response and surreptitiously adding additional rental time without paying for it. The rental server response may have been stored in the predefined memory location as result of the warning supplied to the user in step 530.

A determination is made as to whether the user purchased additional rental time (decision 550). If the user purchased additional rental time, then decision 550 branches to “yes” branch 555 whereupon, at step 560, the encrypted amount of additional time that is stored in the predetermined memory location is decrypted with one or more encryption keys stored in nonvolatile memory of the time-day module. In one embodiment, the encryption keys on the time-day card include a private key assigned to the time-day card and a public key assigned to the rental server. The data stored in the predetermined memory location is encrypted with both the time-day module's public key as well as the rental server's private key. Using asynchronous keys, the encrypted value is then decrypted using the time-day module's private key and the rental server's public key. At step 570, the end time-day rental value is updated based upon the amount of additional time purchased and the updated end time-day value is stored in a secure storage location. In one embodiment, the end time-day value is stored in a nonvolatile storage area of the time-day module. In another embodiment, the end time-day value is encrypted and stored on the computer system's main nonvolatile storage area (e.g., the computer system's hard drive). Processing then loops back to determine if adequate rental time now exists by comparing the updated time-day value with the current time-day value. If sufficient time has been purchased, then decision 520 continues to loop back to step 510 until the purchased rental time has been depleted. On the other hand, if the user failed to purchase enough rental time, then decision 520 would once again branch to “yes” branch 524 and request that the user purchase additional rental time.

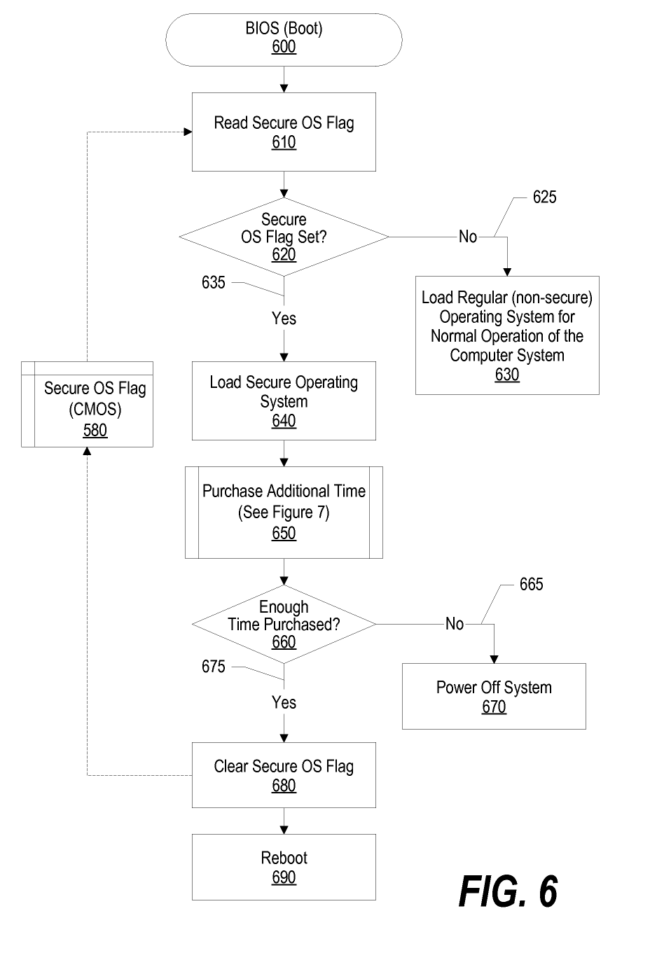

Returning to decision 550, if the user fails to purchase additional rental time, then decision 550 branches to “no” branch 572 whereupon, at step 572, a secure operating system flag is set in nonvolatile (e.g., CMOS) memory 580. At predefined process 590, a reboot of the system is forced (see FIG. 6 and corresponding text for processing details). Because the secure operating system flag is set, when rebooted, the computer system will load the secure operating system. The secure operating system provides a limited amount of functionality, primarily limited to those functions used to purchase additional rental time.

FIG. 6 is a flowchart showing the steps taken by a secure BIOS routine to enforce subscription rules. Processing commences at step 600 when the computer system is rebooted or turned on. At step 610, the BIOS routine reads the secure operating system flag from nonvolatile storage 580. If applicable, the secure operating system flag was set when the rental time-day module routine detected that the purchased rental time had expired (see step 575 in FIG. 5). Returning to FIG. 6, a determination is made as to whether the secure operating system flag has been set (decision 620). If the secure operating system flag has not been set (or has been cleared), then decision 620 branches to “no” branch 625 and, at step 630, the BIOS routine continues loading a non-secure operating system. In a personal computing environment, examples of non-secure operating systems include Microsoft Windows™ operating systems, Linux™ operating systems, UNIX or AIX operating systems, Apple Macintosh operating system (e.g., Mac OS X). As used herein a non-secure operating system does not refer to an operating system that is resistant to malicious code, such as viruses, but rather refers to whether the user is allowed to install, load, and execute a wide variety of software programs. Therefore, as used herein, a “secure operating system” refers to an operating system that restricts actions that can be performed using a computer system by restricting the software applications that can be executed when the computer system is running the secure operating system. In the rental computer environment, the actions that the user is allowed to execute when the computer system is running the secure operating system is/are application(s) that have been installed to allow the user to purchase additional rental time. When the additional rental time has been purchased, as will be seen in steps 640 through 690 of FIG. 6, the computer system is rebooted so that (if sufficient rental time has been purchased), the computer system reboots and loads a non-secure operating system. In a rental mobile telephone application, the non-secure operating system allows the user to use the mobile telephone normally, while the secure operating system would restrict the telephone user to those actions used to purchase additional rental time (e.g., call a predefined telephone number to purchase time, connect the mobile telephone to a computer network where additional time can be purchased, etc.). In an entertainment environment, such as a mobile music player (e.g., an MP3 player, an iPod™, etc.), the secure operating system would restrict the user to actions used to purchase additional time and not allow normal operation of the device, while the non-secure operating system allows normal operation of the device (e.g., play music, etc.).

Returning to decision 620, if the secure operating system flag has been set, then decision 620 branches to “yes” branch 635 whereupon, at step 640, the secure operating system is loaded by the computer system restricting the user's actions to those actions pertaining to purchasing additional rental time for the computer system. At predefined process 650, the user purchases additional rental time while executing the secure operating system (see FIG. 7 and corresponding text for processing details). A determination is then made as to whether the user purchased enough time to continue using the rental computer system (decision 660). If enough time has not been purchased, then decision 660 branches to “no” branch 665 whereupon, at step 670, the rental computer system is powered off. Note, that if the user attempts to power the system back on, the secure operating system flag is still set so the system will execute the steps shown in FIG. 6 and will continue to branch to “yes” branch 635 from decision 620 until enough rental time has been purchased. Returning to decision 660, if the user purchased enough rental time to continue using the computer system, then decision 660 branches to “yes” branch 675 whereupon, at step 680 the secure operating system flag is cleared in nonvolatile memory 580, and the computer system is rebooted at step 690. Note that since the secure operating system flag has been cleared, when the computer system is rebooted and the steps shown in FIG. 6 are re-executed, decision 620 will branch to “no” branch 625 and normal operation of the computer system will commence when the non-secure operating system is loaded.

FIG. 7 is a flowchart showing the steps taken to purchase additional rental time. Operations performed at the rental computer system commence at 700, while operations performed at the rental web server commence at 701. At step 705, the rental computer system requests a secure connection with the rental web server using a protocol such as Secure Socket Layers (SSL) or another secure communication protocol. At 710, the rental web server receives the request and establishes a secure connection with the rental computer system. Returning to processing performed by the rental computer system, at step 715, the rental computer system's identity data is encrypted (e.g., within the secured communication protocol, separately using a shared key, using a public key corresponding to the rental web server, etc.). In one embodiment, the encryption key information used to encrypt the data is stored on the time-day module. At step 720, the rental computer system identity data is transmitted to the rental web server.

Turning back to rental web server processing, at step 725 the rental web server receives and decrypts the rental computer system's identity data and, at step 730, the renter's account information is retrieved from account information data store 740. At step 745, the rental web server uses the account information to create an account update web page that includes details about the rental computer system, including the amount of rental time remaining as well as the cost to purchase additional rental time. This web page is returned to the rental computer system. At step 750, the account update web page is received at the rental computer system and displayed to the user. At predefined processes 760 and 770 the rental computer system and the rental web server, respectively, perform actions to process payment for additional rental time and the rental web server update's the renter's account information to reflect the additional time that has been purchased. See FIG. 8 and corresponding text for details relating to the steps used to process the payment and update the renter's account information. At steps 775 and 785 the rental computer system and the rental web server, respectively, end the secure connection and, at 780 and 790, respectively, processing used to purchase additional rental time ends.

FIG. 8 is a flowchart showing further steps taken during the purchase and update of the additional rental time. Steps performed by the rental computer system are shown commencing at 800 while those performed by the rental web server are shown commencing at 801. At step 805, the user of the rental computer system enters a request for additional rental time and provides payment data (e.g., a credit or debit card number and related details, etc.) and this information is sent to the rental web server.

At step 810, the rental web server receives the request for additional rental time and the payment data. At step 815, the rental web server validates the payment data (e.g., verifies the credit/debit card data for sufficient credit/funds, etc.). A determination is made as to whether the payment information has been validated (decision 820). If the payment information is not validated, decision 820 branches to “no” branch 822 whereupon, at step 825, an error message is returned to the rental computer system, and processing returns to the calling routine (see FIG. 7) at 830. On the other hand, if the payment is validated, then decision 820 branches to “yes” branch 832 whereupon, at step 835, the renter's account information is updated and stored in account information data store 740. At step 840, the time data that includes the amount additional time purchased by the renter is encrypted using both the rental web server's private key and the rental computer system's public key. At step 850, the encrypted time data is sent back to the rental computer system. Rental web server processing then returns to the calling routine at 855 (see FIG. 7).

Turning back to rental computer system processing, at step 860, the rental computer system receives a response from the rental web server in response to the additional rental time request. A determination is made as to whether the response is an error response (decision 865). If the response is an error, then decision 865 branches to “yes” branch 866 which loops back for the user to retry the request for additional rental time (e.g., the user provides a different debit/credit card for payment, etc.). This looping continues until the rental computer system receives a non-error response, at which time decision 865 branches to “no” branch 868 and a determination is made as to whether the rental computer system is currently running the secure operating system (decision 870). If the rental computer system is currently running the secure operating system, then decision 870 branches to “yes” branch 872 whereupon, at step 875, the secure operating system decrypts the responsive rental data using the rental computer system's private key and the rental web server's public key, and at step 880, the secure operating system updates the end time-day rental value to reflect the additional time purchased by the user. On the other hand, if the rental computer system is not currently running the secure operating system and is instead running a regular operating system (e.g., Microsoft Windows™, Linux™, AIX™, etc.), then decision 870 branches to “no” branch 885 whereupon, at step 890, the encrypted response received from the rental web server is stored in a predetermined storage location, such as a mailbox. The next time the system reboots or checks for additional rental time purchases (see FIG. 5), the predetermined storage location will be checked and the additional purchased rental time will be used to update the end time-day value. Note that in the embodiment shown, the encryption keys are not provided from within the non-secure operating system in order to prevent a hacker from using the encryption keys to add additional rental time without paying for it. Rental computer system processing then returns to the calling routine (see FIG. 7) at 895.

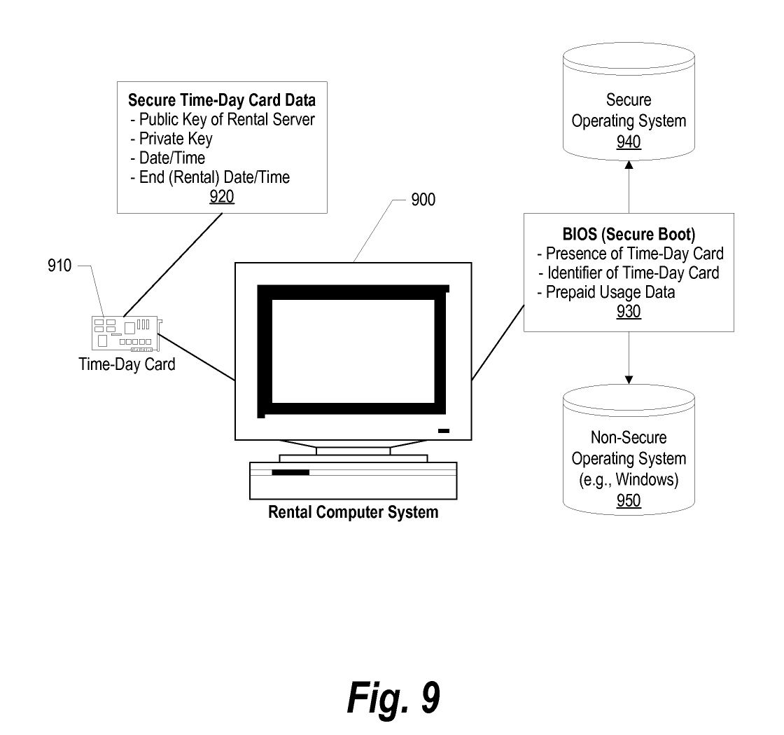

FIG. 9 is a diagram showing components used in the rental computer system. Rental computer system 900 includes time-day card 910. In one embodiment, time-day card 910 is installed in a DIMM (Dual Inline Memory Module) slot and attached to a host bus of the computer system. As described herein, the rental computer system is made inoperable if the time-day card is not present in the computer system. In one embodiment, time-day card 910 includes secure time-day card data 920 that is not accessible by the user of rental computer system 900. This information includes the public key of the rental web server, the private key of the rental computer system, the current time-day value that reflects the current time and date, and the end time-day value that reflects the time and date at which the rental period expires. When booting, rental computer system 900 executes BIOS 930 which includes a secure BIOS routine that cannot be altered by the user of the rental computer system. The secure BIOS routine ensures that the time-day card is installed, reads an identifies of the time-day card to ensure that the time-day card has not been swapped out for a different time-day card with different rental values, and prepaid rental usage data (e.g., the end time-day value, etc.) that indicates when the rental period has expired. As shown, BIOS 930 either loads secure operating system 940 if the rental period has expired or, if the rental period has not expired, then BIOS 930 loads non-secure operating system 950, such as Microsoft Windows™, Linux™, AIX™, or the like.

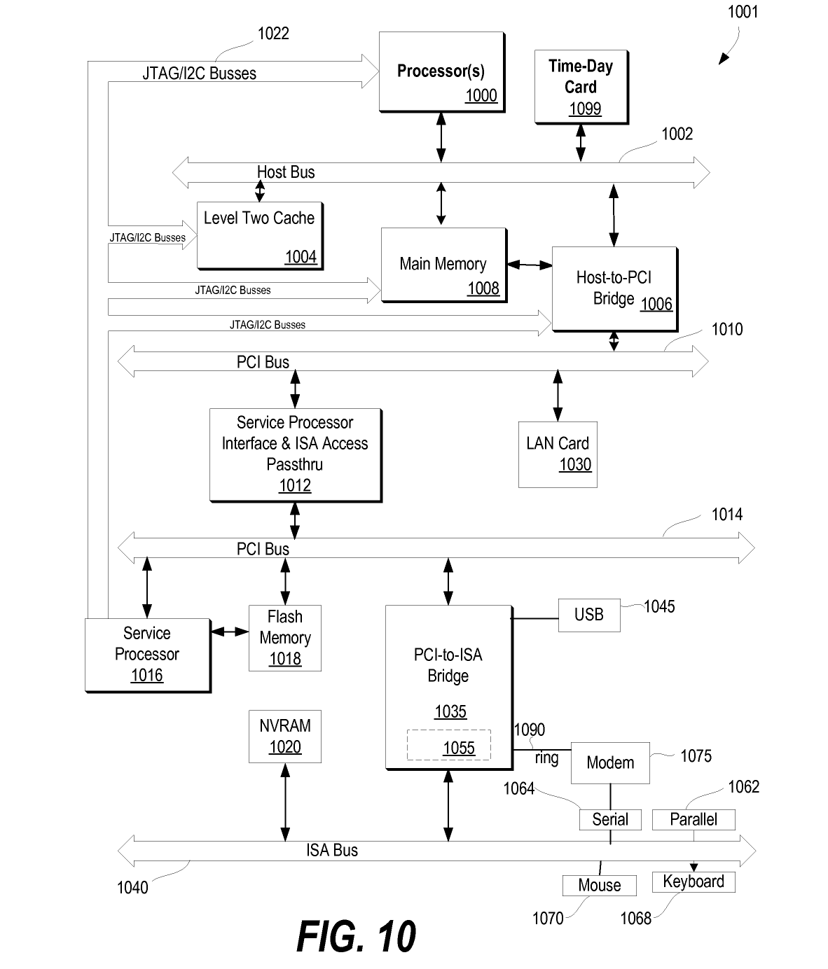

FIG. 10 illustrates information handling system 1001 which is a simplified example of a computer system capable of performing the computing operations described herein. Computer system 1001 includes processor 1000 which is coupled to host bus 1002. Time-day card 1099 and a level two (L2) cache memory 1004 is also coupled to host bus 1002. Host-to-PCI bridge 1006 is coupled to main memory 1008, includes cache memory and main memory control functions, and provides bus control to handle transfers among PCI bus 1010, processor 1000, L2 cache 1004, main memory 1008, and host bus 1002. Main memory 1008 is coupled to Host-to-PCI bridge 1006 as well as host bus 1002. Devices used solely by host processor(s) 1000, such as LAN card 1030, are coupled to PCI bus 1010. Service Processor Interface and ISA Access Pass-through 1012 provides an interface between PCI bus 1010 and PCI bus 1014. In this manner, PCI bus 1014 is insulated from PCI bus 1010. Devices, such as flash memory 1018, are coupled to PCI bus 1014. In one implementation, flash memory 1018 includes BIOS code that incorporates the necessary processor executable code for a variety of low-level system functions and system boot functions.

PCI bus 1014 provides an interface for a variety of devices that are shared by host processor(s) 1000 and Service Processor 1016 including, for example, flash memory 1018. PCI-to-ISA bridge 1035 provides bus control to handle transfers between PCI bus 1014 and ISA bus 1040, universal serial bus (USB) functionality 1045, power management functionality 1055, and can include other functional elements not shown, such as a real-time clock (RTC), DMA control, interrupt support, and system management bus support. Nonvolatile RAM 1020 is attached to ISA Bus 1040. Service Processor 1016 includes JTAG and 12C busses 1022 for communication with processor(s) 1000 during initialization steps. JTAG/12C busses 1022 are also coupled to L2 cache 1004, Host-to-PCI bridge 1006, and main memory 1008 providing a communications path between the processor, the Service Processor, the L2 cache, the Host-to-PCI bridge, and the main memory. Service Processor 1016 also has access to system power resources for powering down information handling device 1001.

Peripheral devices and input/output (I/O) devices can be attached to various interfaces (e.g., parallel interface 1062, serial interface 1064, keyboard interface 1068, and mouse interface 1070 coupled to ISA bus 1040. Alternatively, many I/O devices can be accommodated by a super I/O controller (not shown) attached to ISA bus 1040.

In order to attach computer system 1001 to another computer system to copy files over a network, LAN card 1030 is coupled to PCI bus 1010. Similarly, to connect computer system 1001 to an ISP to connect to the Internet using a telephone line connection, modem 1075 is connected to serial port 1064 and PCI-to-ISA Bridge 1035.

While FIG. 10 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
verifying installation of a secure time-day module in a computer system, wherein the computer system is rendered inoperable if the secure time-day module is not installed;
retrieving a current time-day value from the secure time-day module and an end time-day value from a secure storage area;
comparing the current time-day value to the end time-day value;
determining whether a rental period has expired in response to the comparison; and
preventing use of the computer system in response to determining that the rental period has expired.

2. The method of claim 1 wherein, after determining that the rental period has expired, the method further comprises:
rebooting the computer system and loading a secure operating system during the rebooting, wherein the secure operating system limits execution of software programs to secure operating system software programs that includes a secure operating system software program that facilitates purchase of additional rental time.

3. The method of claim 2 further comprising:
executing the secure operating system software program that facilitates the purchase of additional rental time, the execution including:
sending a request for the additional rental time to a server that is connected to the computer system via a computer network, wherein the request includes payment information;
receiving, from the server, a rental request response; and
updating the end time-day value stored in the secure storage area based on the received rental request response.

4. The method of claim 1 further comprising:
executing, using a non-secure operating system, a software program that facilitates the purchase of additional rental time, the execution including:
sending a request for the additional rental time to a server that is connected to the computer system via a computer network, wherein the request includes payment information;
receiving, from the server, a rental request response; and
updating the end time-day value stored in the secure storage area based on the received rental request response.

5. The method of claim 4 further comprising:
storing the received rental request response in a mailbox;
in response to determining that the rental period has expired:
retrieving the received rental request response from the mailbox; and
updating the end time-day value stored in the secure storage area using the received rental request response.

6. The method of claim 1 wherein the determination as to whether the rental period has expired is performed at a plurality of times, wherein one of the times is during a boot-up sequence of the computer system, the method further comprising:
reading a predefined memory location used to store rental purchase responses in order to determine whether additional rental time has been purchased, the reading performed in response to the rental period being expired;
in response to determining that additional rental time has been purchased:
updating the end time-day value using data stored in the predefined memory location; and
allowing the user to continue using the computer system; and
in response to determining that additional rental time has not been purchased:
setting a secure operating system flag; and
rebooting the computer system after setting the secure operating system flag, wherein, during the rebooting, a BIOS routine operates and loads a secure operating system based on the setting of the secure operating system flag, wherein the secure operating system limits actions performed on the computer system to allowed actions, and wherein one of the allowed actions is to purchase additional rental time.

7. The method of claim 1 further comprising:
booting the computer system, the booting including:
reading a secure operating system flag from a predefined memory location;
loading and executing a non-secure operating system in response to the secure operating system flag being cleared; and
loading and executing a secure operating system in response to the secure operating system flag being set, wherein the secure operating system limits actions performed on the computer system to allowed actions, and wherein one of the allowed actions is to purchase additional rental time, the execution of the secure operating system including:
sending a request for the additional rental time to a server that is connected to the computer system via a computer network, wherein the request includes payment information;
receiving, from the server, a rental request response;
updating the end time-day value stored in the secure storage area based on the received rental request response;
re-comparing the current time-day value to the updated end time-day value;
re-determining whether the rental period has expired in response to the re-comparison; and
in response to determining that the rental period is no longer expired:
clearing the secure operating system flag; and
rebooting the computer system.

8. A information handling system comprising:
one or more processors;
a memory accessible by at least one of the processors;
a nonvolatile storage area accessible by at least one of the processors;
a secure time-day module accessible by at least one of the processors;
a network interface adapter connecting the information handling system to a computer network; and
a set of instructions stored in the memory, wherein one or more of the processors executes the set of instructions in order to perform actions of:
verifying installation of the secure time-day module in a information handling system, wherein the information handling system is rendered inoperable if the secure time-day module is not installed;
retrieving a current time-day value from the secure time-day module and an end time-day value from a secure storage area;
comparing the current time-day value to the end time-day value;
determining whether a rental period has expired in response to the comparison; and
preventing use of the information handling system in response to determining that the rental period has expired.

9. The information handling system of claim 8 wherein the set of instructions perform further actions wherein, after determining that the rental period has expired, the actions further comprise:
rebooting the information handling system and loading a secure operating system during the rebooting, wherein the secure operating system limits execution of software programs to secure operating system software programs that includes a secure operating system software program that facilitates purchase of additional rental time.

10. The information handling system of claim 9 wherein the set of instructions perform further actions comprising:
executing the secure operating system software program that facilitates the purchase of additional rental time, the execution including:
sending, through the network adapter, a request for the additional rental time to a server that is connected to the information handling system via the computer network, wherein the request includes payment information;
receiving, from the server, a rental request response; and
updating the end time-day value stored in the secure storage area based on the received rental request response.

11. The information handling system of claim 8 wherein the set of instructions perform further actions comprising:
executing, using a non-secure operating system, a software program that facilitates the purchase of additional rental time, the execution including:
sending, through the network adapter, a request for the additional rental time to a server that is connected to the information handling system via the computer network, wherein the request includes payment information;
receiving, from the server, a rental request response; and
updating the end time-day value stored in the secure storage area based on the received rental request response.

12. The information handling system of claim 11 wherein the set of instructions perform further actions comprising:
storing the received rental request response in a mailbox;
in response to determining that the rental period has expired:
retrieving the received rental request response from the mailbox; and
updating the end time-day value stored in the secure storage area using the received rental request response.

13. The information handling system of claim 8 wherein the determination as to whether the rental period has expired is performed at a plurality of times, wherein one of the times is during a boot-up sequence of the information handling system, wherein the set of instructions perform further actions comprising:
reading a predefined memory location used to store rental purchase responses in order to determine whether additional rental time has been purchased, the reading performed in response to the rental period being expired;
in response to determining that additional rental time has been purchased:
updating the end time-day value using data stored in the predefined memory location; and
allowing the user to continue using the information handling system; and
in response to determining that additional rental time has not been purchased:
setting a secure operating system flag; and
rebooting the information handling system after setting the secure operating system flag, wherein, during the rebooting, a BIOS routine operates and loads a secure operating system based on the setting of the secure operating system flag, wherein the secure operating system limits actions performed on the information handling system to allowed actions, and wherein one of the allowed actions is to purchase additional rental time.

14. The information handling system of claim 8 wherein the set of instructions perform further actions comprising:
booting the information handling system, the booting including:
reading a secure operating system flag from a predefined memory location;
loading and executing a non-secure operating system in response to the secure operating system flag being cleared; and
loading and executing a secure operating system in response to the secure operating system flag being set, wherein the secure operating system limits actions performed on the information handling system to allowed actions, and wherein one of the allowed actions is to purchase additional rental time, the execution of the secure operating system including:
sending, through the network adapter, a request for the additional rental time to a server that is connected to the information handling system via the computer network,
wherein the request includes payment information;
receiving, from the server, a rental request response;
updating the end time-day value stored in the secure storage area based on the received rental request response;
re-comparing the current time-day value to the updated end time-day value;
re-determining whether the rental period has expired in response to the re-comparison; and
in response to determining that the rental period is no longer expired:
clearing the secure operating system flag; and
rebooting the information handling system.

15. A computer program product stored in a computer readable medium, comprising functional descriptive material that, when executed by a data processing system, causes the data processing system to perform actions that include:
verifying installation of a secure time-day module in a computer system, wherein the computer system is rendered inoperable if the secure time-day module is not installed;
retrieving a current time-day value from the secure time-day module and an end time-day value from a secure storage area;
comparing the current time-day value to the end time-day value;
determining whether a rental period has expired in response to the comparison; and
preventing use of the computer system in response to determining that the rental period has expired.

16. The computer program product of claim 15 wherein, after determining that the rental period has expired, the functional descriptive material causes the data processing system to perform further actions comprising:
rebooting the computer system and loading a secure operating system during the rebooting, wherein the secure operating system limits execution of software programs to secure operating system software programs that includes a secure operating system software program that facilitates purchase of additional rental time.

17. The computer program product of claim 16 wherein the functional descriptive material causes the data processing system to perform further actions comprising:
executing the secure operating system software program that facilitates the purchase of additional rental time, the execution including:
sending a request for the additional rental time to a server that is connected to the computer system via a computer network, wherein the request includes payment information;
receiving, from the server, a rental request response; and
updating the end time-day value stored in the secure storage area based on the received rental request response.

18. The computer program product of claim 15 wherein the functional descriptive material causes the data processing system to perform further actions comprising:
executing, using a non-secure operating system, a software program that facilitates the purchase of additional rental time, the execution including:
sending a request for the additional rental time to a server that is connected to the computer system via a computer network, wherein the request includes payment information;
receiving, from the server, a rental request response;
updating the end time-day value stored in the secure storage area based on the received rental request response; and
storing the received rental request response in a mailbox; and
in response to determining that the rental period has expired:
retrieving the received rental request response from the mailbox; and
updating the end time-day value stored in the secure storage area using the received rental request response.

19. The computer program product of claim 15 wherein the determination as to whether the rental period has expired is performed at a plurality of times, wherein one of the times is during a boot-up sequence of the computer system, wherein the functional descriptive material causes the data processing system to perform further actions comprising:
reading a predefined memory location used to store rental purchase responses in order to determine whether additional rental time has been purchased, the reading performed in response to the rental period being expired;
in response to determining that additional rental time has been purchased:
updating the end time-day value using data stored in the predefined memory location; and
allowing the user to continue using the computer system; and
in response to determining that additional rental time has not been purchased:
setting a secure operating system flag; and
rebooting the computer system after setting the secure operating system flag, wherein, during the rebooting, a BIOS routine operates and loads a secure operating system based on the setting of the secure operating system flag, wherein the secure operating system limits actions performed on the computer system to allowed actions, and wherein one of the allowed actions is to purchase additional rental time.

20. The computer program product of claim 15 further comprising:
booting the computer system, the booting including:
reading a secure operating system flag from a predefined memory location;
loading and executing a non-secure operating system in response to the secure operating system flag being cleared; and
loading and executing a secure operating system in response to the secure operating system flag being set, wherein the secure operating system limits actions performed on the computer system to allowed actions, and wherein one of the allowed actions is to purchase additional rental time, the execution of the secure operating system including:
sending a request for the additional rental time to a server that is connected to the computer system via a computer network, wherein the request includes payment information;
receiving, from the server, a rental request response;
updating the end time-day value stored in the secure storage area based on the received rental request response;
re-comparing the current time-day value to the updated end time-day value;
re-determining whether the rental period has expired in response to the re-comparison; and
in response to determining that the rental period is no longer expired:
clearing the secure operating system flag; and
rebooting the computer system.
